(19) United States
(12) Patent Application Publication
(10) Pub. No.: US 2013/0191890 A1
(43) Pub. Date: Jul. 25, 2013

(54) METHOD AND SYSTEM FOR USER IDENTITY RECOGNITION BASED ON SPECIFIC INFORMATION

(71) Applicant: BroadDeep (Beijing) Network Technology Co., Ltd, Beijing (CN)

(72) Inventors: Qiang Li, Beijing (CN); Mingjie Qian, Beijing (CN)

(73) Assignee: BROADDEEP (BEIJING) NETWORK TECHNOLOGY CO., LTD, Beijing (CN)

(21) Appl. No.: 13/746,130

(22) Filed: Jan. 21, 2013

(30) Foreign Application Priority Data
Jan. 21, 2012 (CN) 201210019678.5

(51) Int. Cl. G06F 21/31

(52) U.S. Cl. CPC G06F 21/31
USPC 726/5

(57) ABSTRACT

The invention relates to a method and a system for user identity recognition based on specific information, which involves identifying user temporary unique identification associated with specific information based on the specific information, which represents user access to the internet; acquiring user temporary unique identification and user identity information from a communication network side; and associating the user identity information with the specific information based on the user temporary unique identification, wherein the associated information is used for providing the user identity information to the external. The method and system can associate specific information with user identity information based on user temporary unique identification so as to provide internet applications with the user identity information corresponding to the specific information. The internet applications can thereby carry on subsequent actions, such as analysis of user behavior and precision marketing, and can also process user positioning against network security events.

This application claims priority under 35 U.S.C. §119 to Chinese Patent Application No. 201210019678.5, filed Jan. 21, 2012, the entire disclosure of which is hereby incorporated by reference as if set forth fully herein.

### BACKGROUND OF THE INVENTION

1. Field of the Invention

The invention relates to network technology, and particularly to user identity recognition based on specific information for network.

2. Description of the Related Technology

With increasingly matured network technology, internet applications, especially mobile internet applications, are rapidly developing. Users can directly use many internet applications, which, in order to attract users, do not even require registration before use.

It has been found in the process of achieving the present invention that conventional internet applications are often unable to obtain user identity information, which is disadvantageous to the development of internet applications. For example, such internet applications cannot adequately analyze user behavior or serve to create precision marketing strategy, etc. For another example, a service provider of an internet application may desire to obtain identity information of users who have accessed the internet application so as to adapt its own system to demand from the internet, but cannot be conveniently done at present. Moreover, the number of network security events uncovered by internet intrusion detection, honeypot trapping technology, security emergency response and other event monitoring technologies has been on the rise. However, such event monitoring technologies are often confined to recognizing specific network security events, and are not capable of determining user identities corresponding to the network security events, thus it is inconvenient positioning users involved.

In view of the above defects existed in conventional internet applications and network security, the inventor, based on his rich practical experiences and professional knowledge in designing or manufacturing such products, designed a method and a system for user identity recognition based on specific information for network. Adopting the invention, internet applications can obtain user identity information and therefore realize user positioning.

### SUMMARY OF THE INVENTION

An object of the present invention is to overcome defects in the existing internet applications and network security techniques and provide a method and a system for user identity recognition based on specific information. A technical problem to be solved is how to obtain user identity information based on specific information representing user access to the internet, thereby promoting development of internet applications and improving internet security.

In order to achieve the above-mentioned object of the invention and solve the technical problem, the invention provides a technical solution as will be illustrated below.

The invention provides a method for user identity recognition based on specific information, comprising: determining a temporary unique user label associated with specific information based on the specific information, which represents the user's access to the internet; acquiring the temporary unique user label and user identity information from a communication network; correlating the user identity information with the specific information based on the temporary unique user label, wherein the correlation information is used for providing the user identity information to the a party outside the communication network.

The object of the invention and the technical problem can also be achieved by the following technical solutions.

Preferably, the specific information includes at least one of characteristic information of network, characteristic information of user behavior and characteristic information of content accessed by the user.

Preferably, the characteristic information of the network includes at least one of a source IP address, a source port number, a destination IP address and a destination port number.

Preferably, the characteristic information of user behavior includes at least one of a Uniform Resource Locator (URL), a subscriber number of an instant massaging tool, a File Transfer Protocol (FTP) address, a video-on-demand address and characteristic information of a hacking attack.

Preferably, the characteristic information of content accessed by the user includes a numeric string or an alphabetic string from the content accessed by the user or a combination of multiple information pieces from the content accessed by the user.

Preferably, the temporary unique user label includes the IP address and/or the Median Access Control (MAC) address of the user's device.

Preferably, said determining the temporary unique user label associated with specific information based on the specific information includes: in case where the characteristic information of network is a source IP address, determining the temporary unique user label as the source IP address; in case where the characteristic information of network is a source IP address and a source port number, determining the temporary unique user label as the source IP address and the source port number; or in case where the characteristic information of network does not include a source IP address, parsing data transferred from the communication network and acquiring the temporary unique user label from the parsed data that contains the specific information.

Preferably, said acquiring the temporary unique user label and user identity information from the communication network includes: parsing the temporary unique user label and the user identity information from the transferred data by existing network equipments in the communication network, wherein the existing network equipments include a Remote Authentication Dial in User System (Radius) equipment, a Gateway GPRS Support Node (GGSN), a Packet Date Serving Node (PDSN), a Wireless Application Protocol (WAP) gateway or an integration gateway; or providing a Deep Packet Inspection (DPI) equipment at the communication network, parsing data transferred in the communication network by the DPI equipment and acquiring the temporary unique user label and the user identity information from the parsed data.

Preferably, the user identity information includes: a mobile number, International Mobile Subscriber Identity (IMSI), International Mobile Equipment Identity (IMEI), an Asymmetric Digital Subscriber Loop (ADSL) account or a Wireless Local Area Network (WLAN) account.

Preferably, the aforementioned method further comprises: receiving a query that contains specific information, and acquiring and outputting corresponding user identity information from the associated information based on the specific information in the query; or inserting the user identity information from the associated information into a data message containing the specific information.

The invention further provides a system for user identity recognition based on specific information, comprising: a specific information processing module for determining a temporary unique user label associated with specific information based on the specific information, the specific information representing the user's access to internet; an identity information acquiring module for acquiring the temporary unique user label and user identity information from a communication network; an correlation module for correlating the user identity information with the specific information based on the temporary unique user label, wherein the correlation information is used for providing the user identity information to a party outside the communication network.

Preferably, the correlation module is further used for inserting the user identity information from the correlation information into a data message containing the specific information.

Preferably, the system further comprises: a data storage module for storing the correlation information; a query module for receiving a query that contains specific information, acquiring corresponding user identity information from the correlation information based on the specific information in the query and outputting the user identity information, wherein the query module receives the query input through File Transfer Protocol (FTP), Secure File Transfer Protocol (SFTP), Secure Copy (SCP), Hyper Test Transport Protocol (HTTP) or Web service.

The method and the system for user identity recognition based on specific information according to the present invention have at least the following advantages: the invention can associate specific information with user identity information based on a temporary unique user label by mapping the specific information of a user's access to the internet to the temporary unique user label so as to provide internet applications with the user identity information corresponding to the specific information. The internet applications can thereby carry on subsequent actions, such as analysis of user behavior and precision marketing, and can also process user positioning against network security events. In addition, the technical solutions of the invention have little impact on network performance. As a result, the technical solutions provided by the invention can promote development of internet applications and improve network security.

The above section is only an overview of the technical solutions of the invention. In order to allow the technical means of the invention to be better understood, specific embodiments are described below. Further objects, characteristics and advantages of the invention will become clearer from the following description of preferred embodiments as well as from the drawing.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a flow diagram showing the method for user identity recognition based on specific information according to the present invention.

FIG. 2 is a diagram illustrating a position of the system for user identity recognition based on specific information according to the present invention in a communication system.

FIG. 3 a structure diagram of the system for user identity recognition based on specific information according to the present invention.

### DETAILED DESCRIPTION OF THE PREFERRED EMBODIMENT(S)

In order to further describe the technical means adopted to achieving the object of the invention and the effects thereof, the details, structure, characteristics, technical process and effects of the method and the system for user identity recognition based on specific information provided by the invention will be described in detail below.

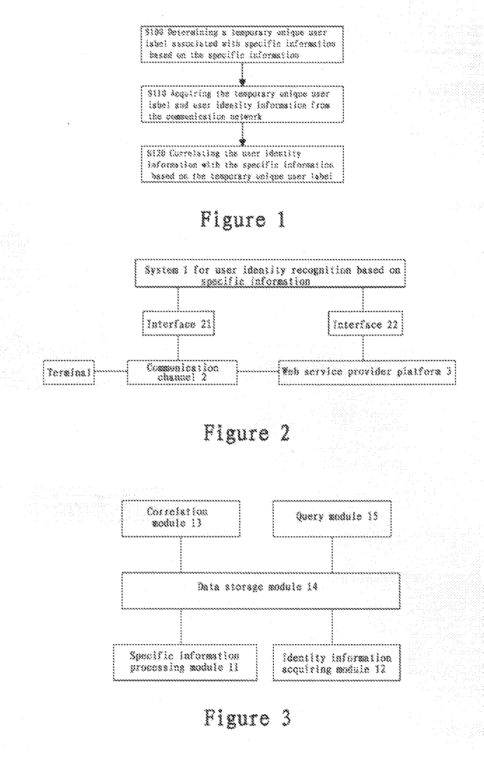

Embodiment 1 shows a method for user identity recognition based on specific information. The flow diagram of this method for user identity recognition is as shown in FIG. 1.

In FIG. 1, step S100 is to identify a temporary unique user label associated with specific information based on the specific information.

Specifically, according to the invention, the specific information is mainly used for representing user access to the internet. For example, the specific information may include at least one of characteristic information of network, characteristic information of user behavior and characteristic information of user access content.

The characteristic information of network thereof may specifically include at least one of a source IP address, a source port number, a destination IP address and a destination port number; the characteristic information of user behavior may include at least one of a Uniform Resource Locator (URL), a subscriber number of an instant massaging tool, a File Transfer Protocol (FTP) address, a video-on-demand address and characteristic information of a hacking attack; and the characteristic information of user access content may include a numeric string or an alphabetic string in the user access content, or a combination of multiple information in the user access content. The concrete form of the specific information according to the invention shall not be limited.

The specific information of user access to the internet herein may be input from the external. According to one embodiment, the inventor may set up an interface outwards, through which a query term for inquiring user identity information input from the external, such as internet service provider platform of an internet application, is received. The query term may include specific information of user access to the internet. This interface may also be called a query interface of user identity information. According to the invention, query results may be output through this interface to feed back user identity information that corresponds to the specific information to the requester.

The above query interface may interact with the external information in a way of File Transfer Protocol (FTP), Secure File Transfer Protocol (SFTP), Secure Copy (SCP), Hyper Test Transport Protocol (HTTP) or Web service (WEBSERVICE) so as to receive specific information input from the external and output user identity information that corresponds to the specific information to the external.

Additionally, according to the invention, specific information can also be acquired from a data message transferred by network equipments, for example, specific information can be acquired from a message on basis of FTP, SFTP, SCP, HTTP or WEBSERVICE transferred in the network. According to one embodiment, a terminal account number, a start timestamp, an end timestamp, a source IP address, a source port number and type of an upper layer protocol can be acquired from a message transferred by network equipments. According to another embodiment, a timestamp, a source IP address, a destination IP address, a source port number, a destination port number, type of an upper layer protocol, relevant protocol information such as a QQ number, URL information and characteristic information of a hacking attack can be acquired from a message transferred by network equipments.

In case where the characteristic information of network is a source IP address, the source IP address may directly be identified as a temporary unique user label, i.e., the temporary unique user label is equivalent to the characteristic information of network.

In case where the characteristic information of network is a source IP address and a source port number, the source IP address and the source port number may directly be identified as the temporary unique user label, i.e., the temporary unique user label is equivalent to the characteristic information of network.

In case where the characteristic information of network does not include a source IP address, the inventor may parse data messages transferred from the communication network side to acquire the temporary unique user label from the parsed data messages that contain specific information and bind the acquired temporary unique identification to the specific information.

The temporary unique user label according to the invention may include the IP address and/or the Median Access Control (MAC) address of the user.

It should be noted that one piece of specific information may correspond to a single temporary unique user label, and may also correspond to multiple temporary unique user labels, i.e., there may be either a one-to-one correspondence or a one-to-multi correspondence between the specific information and the temporary unique user labels.

Step S110 is to acquire the temporary unique user label and user identity information from communication network side.

Specifically, according to the invention the temporary unique user label and the corresponding user identity information may be acquired from existing network equipments in the communication network side, i.e., the temporary unique user label and the corresponding user identity information are provided by existing network equipments in the communication network side. For example, existing network equipments are used to parse data messages and acquire the temporary unique user label and its corresponding user identity information from a relevant data message, such as a signaling data message, based on the parse results. The above existing network equipments at the communication network side may include a Remote Authentication Dial in User System (Radius) equipment, a Gateway GPRS Support Node (GGSN), a Packet Date Serving Node (PDSN), a Wireless Application Protocol (WAP) gateway, an integration gateway or the like.

Additionally, according to the invention, a Deep Packet Inspection (DPI) equipment may also be set at the communication network side. The DPI equipment deeply inspects data messages, such as parses the data messages, which are transferred at the communication network side so as to acquire the temporary unique user label and corresponding user identity information from a relevant data message such as a signaling data message of the user based on the inspecting results.

The user identity information herein may specifically include a mobile number, International Mobile Subscriber Identity (IMSI), International Mobile Equipment Identity (IMEI), an Asymmetric Digital Subscriber Loop (ADSL) account, a Wireless Local Area Network (WLAN) account or the like.

The temporary unique user label and the user identity information acquired in above step S110 may be a single temporary unique user label and single user identity information, but also multiple temporary unique user labels and user identity information corresponding to each single temporary unique user label, i.e. multiple user identity information.

It should be noted that, according to the embodiment, the steps S100 and S110 are described in the order. However, in practice, there is no particular order between S100 and S110, i.e. they can be carried out in parallel.

Step S120 is to associate user identity information with specific information based on the temporary unique user label. The associated information may be used for providing user identity information to the external, such as providing query results or inserting user identity information into a data message transferred in the network, wherein the query term to be inquired contains specific information.

Specifically, according to the invention, correspondence between specific information and the temporary unique user label may be acquired through the above step S100 and correspondence between the temporary unique user label and user identity information may be acquired through the above step S110. Thus, the specific information may be associated with the user identity information based on the temporary unique user label in the two sets of correspondences by using a predetermined algorithm. Additionally, an association may be created among the user identity information, the temporary unique user label and the specific information.

The above associated information can be either directly output as the query results or stored for subsequent queries by requesters. That is, according to the invention a query term may be firstly expected, historic data may be collected based on the expected query term, and then the collected historic data may be used as basic data for a requester to query. The data can also be directly collected in the network for specific targets based on a query term set by a requester and the finally obtained specific information and user identity information associated with each other may be output to the requester as query results.

In case where a data message with specific information is transferred in the network, the invention may insert the finally obtained user identity information into the data message and proceed the subsequent transmission of the data message, so that the receiver of the data message, such as an internet application, etc., can acquire the user identity information.

The above associated information can be stored in a database or a file in XML or plain text. According to the invention, the associated information can also be compressed.

Here is one example of each step described above according to the method of the invention: with respect to the specific information of /sf2/sbyy.jsp, /sf2/sbyy.jsp is converted into a temporary unique user label, such as a IP address 10.1.2.3, through the IP layer information of a network message; a mobile number 13910272151 corresponding to 10.1.2.3 is acquired from a data message transferred in the network, the mobile number 13910272151 is bound to /sf2/sbyy.jsp and the mobile number 13910272151 is inserted into the network message. Additionally, according to the invention, the binding information can be stored.

Embodiment 2 shows a system for user identity recognition based on specific information. This system for user identity recognition is as shown in FIG. 2 and FIG. 3.

In FIG. 2, a system for user identity recognition based on specific information 1 of the invention is connected through signals to a communication channel 2 consisting of multiple communication network equipments through an interface 21 and the system for user identity recognition 1 is connected through signals to a service provider platform 3 of an internet application through an interface 22. Additionally, a terminal can access to the service provider platform 3 of the internet application through the communication channel 2.

Specifically, the system for user identity recognition 1 enables transfer of information such as user identity information, the temporary unique user label and specific information with the communication channel 2 through the interface 21; the system for user identity recognition 1 enables transfer of information such as specific information, temporary unique identification and user identity information with the service provider platform 3 of the internet application through the interface 22.

Protocols and message formats adopted by said interface 21 and interface 22 can be set according to actual network circumstances. Said communication channel 2 may include existing network equipments at the communication network side, such as a Radius equipment, a GGSN, a PDSN, a WAP gateway or an integration gateway, which can inspect data messages, and may also include a DPI equipment set at the network side specifically by bypass means such as spectrum or mirror-image. According to the invention, the names of the communication equipments included in the interfaces 21-22 and the communication channel 22 are not limited.

The structure of the system for user identity recognition based on specific information according to the invention is as shown in FIG. 3.

In FIG. 3, a system for user identity recognition specifically comprises a specific information processing module 11, an identity information acquiring module 12 and an associating module 13. This system may further comprise a data storage module 14 and a query module 15. In case where the system does not include the data storage module 14 and the query module 15, the associating module 13 is respectively connected to the specific information processing module 11 and the identity information acquiring module 12. In case where the system includes the data storage module 14 and the query module 15, the data storage module 14 is respectively connected to the specific information processing module 11, the identity information acquiring module 12, the associating module 13 and the query module 15; and the query module 15 may also be connected to the specific information collecting and processing module 12.

The specific information processing module 11 is mainly used for identifying a temporary unique user label associated with specific information based on the specific information.

Specifically, in case where the characteristic information of network is a source IP address, the specific information processing module 11 may directly identify the source IP address as a temporary unique user label, i.e., the temporary unique user label is equivalent to the characteristic information of network.

In case where the characteristic information of network is a source IP address and a source port number, the specific information processing module 11 may directly identify the source IP address and the source port number as a temporary unique user label, i.e., the temporary unique user label is equivalent to the characteristic information of network.

In case where the characteristic information of network does not include a source IP address, data messages transferred from the communication network side may be parsed, so that the specific information processing module 11 acquires the temporary unique user label from the parsed data messages that contain specific information and binds the acquired temporary unique identification to the specific information.

The specific information processing module 11 can be set in the Radius equipment, GGSN, PDSN, WAP gateway, integration gateway or DPI equipment.

The specific information processing module 11 can parse data messages transferred in the network according to the specific information transferred from the query module 15 so as to acquire the temporary unique user label associated with the specific information from the data messages that contain the specific information.

Additionally, the specific information processing module 11 can also acquire specific information from the acquired data messages such as messages transferred by the network equipments, for example, the specific information processing module 11 acquires specific information from data messages on basis of FTP, SFTP, SCP, HTTP or WEBSERVICE, which are transferred in the network. For one example, the specific information processing module 11 can acquire a terminal account number, a start timestamp, an end timestamp, a source IP address, a source port number and type of an upper layer protocol from a message transferred by network equipments. For another example, the specific information processing module 11 can acquire a timestamp, a source IP address, a destination IP address, a source port number, a destination port number, type of an upper layer protocol, relevant protocol information such as a QQ number, URL information and characteristic information of a hacking attack from a message transferred by network equipments.

The specific information processing module 11 can store the acquired specific information and the temporary unique user label associated with the specific information in the data storage module 14.

The identity information acquiring module 12 is mainly used for acquiring the temporary unique user label and user identity information from the communication network side.

Specifically, the identity information acquiring module 12 can acquire the temporary unique user label and user identity information from existing network equipments at the communication network side, such as a Radius equipment, a GGSN, a PDSN, a WAP gateway or an integration gateway. Additionally, the identity information acquiring module 12 can be set in a DPI equipment, which is set at the network side by bypass means, so that the identity information acquiring module 12 acquires the temporary unique user label and user identity information through inspection of the acquired data messages.

The existing equipments at the network side can parse data messages transferred by them, acquire the temporary unique user label and corresponding user identity information from a relevant data message such as a signaling data message of the user based on the parse results, and then provide them to the identity information acquiring module 12. The identity information acquiring module 12 can store the acquired temporary unique user label and the corresponding user identity information in the data storage module 14. Additionally, the identity information acquiring module 12 in the DPI equipment can parse the acquired data messages and acquire the temporary unique user label and corresponding user identity information from a relevant data message based on the parse results.

The user identity information acquired by the identity information acquiring module 12 may include mobile number, IMSI, IMEI, ADSL account or WLAN account.

It should be noted that the operations by the specific information processing module 11 and the identity information acquiring module 12 can be performed in parallel and not be limited to a particular order.

The associating module 13 is mainly used for associating the user identity information with the specific information based on the temporary unique identification. The associated information acquired after associating operation by the associating module 13 may be used for providing the query results to the external.

Specifically, the specific information processing module 11 can acquire a correspondence between the specific information and the temporary unique user label and the identity information acquiring module 12 can acquire a correspondence between the temporary unique user label and the user identity information. Thus, the associating module 13 can associate the specific information with the user identity information based on the temporary unique user label in the two sets of correspondences by using a predetermined algorithm. Additionally, the associating module 13 can also create an association among the user identity information, the temporary unique user label and the specific information.

The associating module 13 can provide the above associated information as query results to the query module 15 and can also store the associated information in the data storage module 14, prepared for subsequent queries by requesters. The associating module 13 can insert the user identity information in the associated information into a data message with specific information.

The associated information acquired by the associating module 13 can be information of a binding between the identity information such as MSISDN/IMSI in GPRS and the specific information, information of a binding between the identity information such as MSISDN/IMSI in PDSN and the specific information, or information of a binding between the identity information such as account information in ADSL/WLAN and the specific information.

The data storage module 14 is mainly used for storing the associated information transferred form the associating module 13. The data storage module 14 can also be used for storing the correspondence between the specific information and the temporary unique user label transferred from the specific information processing module 11 and the correspondence between the temporary unique user label and the user identity information transferred from the identity information acquiring module 12. The data storage module 14 stores the received associated information and the binding information in a database or a file in XML or plain text and can compress the above associated information stored therein.

The query module 15 is mainly used for receiving query terms that contain specific information input form the external, acquiring corresponding user identity information from the associated information stored in the data storage module 14 based on the specific information in the query terms and outputting the user identity information.

The query module 15 may be a query interface of the system according to the invention. The query module 15 can interact with the external information in a way of FTP, SFTP, SCP, HTTP or WEBSERVICE so as to receive specific information input from the external and output user identity information corresponding to the specific information to the external.

Here is one example of the modules described above according to the system of the invention: with respect to the specific information of /sf2/sbyy.jsp, the specific information processing module 11 converts /sf2/sbyy.jsp into a temporary unique user label such as a IP address 10.1.2.3 through the IP layer information of a network message based on the interface 21; the identity information acquiring module 12 acquires a mobile number 13910272151 corresponding to 10.1.2.3 from a data message transferred in the network based on the interface 21; the associating module 13 binds the mobile number 13910272151 to /sf2/sbyy.jsp and stores the binding information into the data storage module 14.

In the above embodiment, the associating module 13 can bind the specific information to the user identity information and output the binding. The following is an example of XML-based query results that contain binding information output from the associating module 13.

```
      <?xml version=“1.0” encoding=“UTF-8”>
    <task id=“1” type=“ msisdn_locate” emergency=“true”>
          <src_ip>122.102.133.2</src_ip>
      <src_port> 5060 </src_port>
          <digest>http://wap.baidu.com</digest>
          <starttime>2010-01-18 12:00:00</starttime>
          <endtime>2010-01-18 12:00:10</endtime>
    <start_record>5</start_record >
    <end_{—} record>15</end_record >
    </task>
</xml>
Type: msisdn_locate query msisdn number,
src_ip : source IP of data message
src_port : source port
digest : specific information
starttime : query Internet users at or after this time
endtime : query Internet users at or before this time
start_record : start record of current query results
end_record: end record of current query results
```

In the above embodiment, the associating module 14 can also directly insert the queried user identity information into a communication message that contains specific information received by the network equipments such as a DPI equipment. For example, the data message that contains the specific information of /sf2/sbyy.jsp received by the network equipments is the following:

GET
/sf2/sbyy.jsp?v=30001&imei=358321039766405&number=
13505170150&ua=002&extc
hid=11003&productid=20000&ps=QrjmkQvolkP HTTP/1.1
Connection: Keep-Alive
Host:10.0.0.172:80
X-Online-Host:122.70.145.21:80
Accept:text/html,text/css,multipart/mixed,application/java-archive, Accept-
Charset: iso-8859-1, utf-8; q=0.7, *; q=0.7
Accept-Language: zh-cn, zh

A data message obtained after the data message received by the associating module 13 being inserted with user identity information, X-Caller-ID: 13910272151:, may be:

GET
/sf2/sbyy.jsp?v=30001&imei=358321039766405&number=
13505170150&ua=002&extc
hid=11003&productid=20000&ps=QrjmkQvolkP HTTP/1.1
Connection: Keep-Alive
Host:10.0.0.172:80
X-Online-Host:122.70.145.21:80
X-Caller-ID:13910272151
Accept:text/html,text/css,multipart/mixed,application/java-archive, Accept-
Charset: iso-8859-1, utf-8; q=0.7, *; q=0.7
Accept-Language: zh-cn, zh

It is to be understood, however, that above-discussed embodiments are only preferred embodiments according to the present invention, but are not meant to limit the scope of the present invention. Although the present invention discloses the above preferred embodiments, any person skilled in the art can appropriately improve or modify the illustrated technical contents into equivalents with no extension of the scope of the technical solutions of the present invention. Any equivalents of the invention or modifications based on the spirit and principle of the invention are within the scope of the invention.

What is claimed is:

1. A method for user identity recognition based on specific information, comprising:
determining a temporary unique user label associated with specific information based on the specific information, the specific information representing the user's access to the internet;
acquiring the temporary unique user label and user identity information from a communication network;
correlating the user identity information with the specific information based on the temporary unique user label,
wherein the correlation information is used for providing the user identity information to a party outside the communication network.

2. The method for user identity recognition based on specific information of claim 1, wherein the specific information includes at least one of characteristic information of network, characteristic information of user behavior or characteristic information of content accessed by the user.

3. The method for user identity recognition based on specific information of claim 2, wherein the characteristic information of network includes at least one of a source IP address, a source port number, a destination IP address and a destination port number.

4. The method for user identity recognition based on specific information of claim 2, wherein the characteristic information of user behavior includes at least one of a Uniform Resource Locator URL, a subscriber number of an instant massaging tool, a File Transfer Protocol (FTP) address, a video-on-demand address and characteristic information of a hacking attack.

5. The method for user identity recognition based on specific information of claim 2, wherein the characteristic information of content accessed by the user includes at least one of a numeric string or an alphabetic string from the content accessed by the user, or a combination of multiple information pieces from the content accessed by the user.

6. The method for user identity recognition based on specific information of claim 1, wherein the temporary unique user label includes the IP address and/or the Median Access Control (MAC) address of the user's device.

7. The method for user identity recognition based on specific information of claim 1, wherein said determining the temporary unique user label associated with specific information based on the specific information includes:
in case where the characteristic information of network is a source IP address, determining the temporary unique user label as the source IP address; or
in case where the characteristic information of network is a source IP address and a source port number, determining the temporary unique user label as the source IP address and the source port number; or
in case where the characteristic information of network does not include a source IP address, parsing data transferred from the communication network and acquiring the temporary unique user label from the parsed data that contains the specific information.

8. The method for user identity recognition based on specific information according to claim 1, wherein said acquiring the temporary unique user label and the user identity information from the communication network includes:
parsing the temporary unique user label and the user identity information from the transferred data by an existing network device in the communication network, wherein the existing network device includes a Remote Authentication Dial in User System (Radius) device, a Gateway GPRS Support Node (GGSN), a Packet Date Serving Node (PDSN), a Wireless Application Protocol (WAP) gateway or an integration gateway; or
providing a Deep Packet Inspection (DPI) device at the communication network, parsing data transferred in the communication network by the DPI device and acquiring the temporary unique user label and the user identity information from the parsed data.

9. The method for user identity recognition based on specific information according to claim 1, wherein the user identity information includes a mobile number, International Mobile Subscriber Identity (IMSI), International Mobile Equipment Identity (IMEI), an Asymmetric Digital Subscriber Loop (ADSL) account or a Wireless Local Area Network (WLAN) account

10. The method for user identity recognition based on specific information according to claim 1, further comprising:
receiving a query that contains specific information, acquiring corresponding user identity information from the associated information based on the specific information in the query and outputting the user identity information; or
inserting the user identity information from the associated information into a data message containing the specific information.

11. A system for user identity recognition based on specific information, comprising:
a specific information processing module for determining a temporary unique user label associated with specific information based on the specific information, the specific information representing the user's access to the internet;
an identity information acquiring module for acquiring the temporary unique user label and user identity information from a communication network;
a correlation module for correlating the user identity information with the specific information based on the temporary unique user label, wherein the correlation information is used for providing the user identity information to a party outside the communication network.

12. The system for user identity recognition based on specific information of claim 11, wherein the correlation module is further used for inserting the user identity information from the correlation information into a data message containing the specific information

13. The system for user identity recognition based on specific information of claim 11, further comprising:
a data storage module for storing the correlation information;
a query module for receiving a query that contains specific information, acquiring corresponding user identity information from the correlation information based on the specific information in the query and outputting the user identity information,
wherein the query module is operable to receive the query input through File Transfer Protocol (FTP), Secure File Transfer Protocol (SFTP), Secure Copy (SCP), Hyper Test Transport Protocol (HTTP) or Web service.
